(19) United States
(12) Patent Application Publication
(10) Pub. No.: US 2024/0010055 A1
(43) Pub. Date: Jan. 11, 2024

(54) VEHICLE CURTAIN CAPABLE OF BEING USED IN DOUBLE-LAYER

(71) Applicant: Zhiling LIU, Guangzhou (CN)

(72) Inventor: Zhiling LIU, Guangzhou (CN)

(21) Appl. No.: 17/973,360

(22) Filed: Oct. 25, 2022

(30) Foreign Application Priority Data
Jul. 7, 2022 (CN) 2022217324807
Sep. 28, 2022 (CN) 202225855028

(51) Int. Cl. B60J 1/20; B32B 5/02; B32B 7/09; B32B 5/26; B32B 3/14

(52) U.S. Cl. CPC B60J 1/2088; B32B 5/028; B32B 7/09; B32B 5/26; B32B 3/14; B32B 5/024; B32B 2605/003; B32B 2250/20; B32B 2307/412; B32B 2307/4026

(57) ABSTRACT

A vehicle curtain capable of being used in double-layer includes an outer mesh cloth, an interlayer plain cloth, and an inner covering plain cloth. The outer mesh cloth and the inner covering plain cloth are respectively arranged on an outer side and an inner side of the interlayer plain cloth, and an edge of the outer mesh cloth is disposed with several mounting connection blocks. The interlayer plain cloth includes an upper interlayer plain cloth and a lower interlayer plain cloth, the upper interlayer plain cloth is sewn and connected to the outer mesh cloth, and the lower interlayer plain cloth and the upper interlayer plain cloth are movably connected. By using a double-layer structure, a user can open and close the lower interlayer plain cloth through a guide rail or a zipper to realize semi shading and full shading functions of a vehicle window thereby greatly improving user's experience.

### TECHNICAL FIELD

The disclosure relates to the field of vehicle sunshade products, and more particularly to a vehicle curtain capable of being used in double-layer.

### BACKGROUND

With rapid development of the social economy and continuous improvement of people's living standards, vehicle ownership has shown a rapid growth trend, and a market of vehicle related accessories (also referred to auto parts market) is also growing. In hot summer, in order to block high temperature exposure and reduce scattering of a sunlight source, people usually choose to install vehicle curtains in the vehicle. However, most of the current vehicle curtains are installed with a single curtain cloth matched with a slide rail, but in this situation, only one of possibilities of full shading or semi shading can be selected, and therefore it has a single function and cannot meet usage demands of consumers.

### SUMMARY

A purpose of the disclosure is to overcome the shortcomings in the related art as mentioned above, and a vehicle curtain capable of being used in double-layer is proposed. A design of a multi-layer e.g., double-layer structure is used, and a user can choose two functions of full shading or semi shading, which greatly improves user's experience.

In order to achieve the above purposes, the disclosure provides the following technical solutions. Specifically, a vehicle curtain includes an outer mesh cloth and an interlayer plain cloth. An edge of the outer mesh cloth is disposed with multiple mounting connection blocks. The interlayer plain cloth includes an upper interlayer plain cloth and a lower interlayer plain cloth, the upper interlayer plain cloth is sewn and connected to the outer mesh cloth, and the lower interlayer plain cloth is movably connected to the upper interlayer plain cloth. In this solution, a double-layer structure is used, and users can open and close the lower interlayer plain cloth through a guide rail or a zipper to realize the semi shading function (that is, shading light only through the outer mesh cloth) and the full shading function of a vehicle window.

In an embodiment, the upper interlayer plain cloth is disposed with a guide rail, the guide rail is slidably disposed with multiple hooks, and the lower interlayer plain cloth is connected to the multiple hooks. In this situation, the movement of the lower interlayer plain cloth is smoother through the sliding of the multiple hooks. The upper interlayer plain cloth may be further disposed with a curtain head configured (i.e., structured and arranged) to hide the guide rail and the multiple hooks, and the curtain head is sewn by a folding portion of the upper interlayer plain cloth. The guide rail is hidden inside the upper interlayer plain cloth, on the one hand, the product is more beautiful, and on the other hand the guide rail and the hooks are protected from being damaged.

In an embodiment, the lower interlayer plain cloth is detachably connected to the upper interlayer plain cloth through one selected from the group consisting of buttons, straps, magic tapes (also referred to as VELCRO), and zippers. The user can directly remove the lower interlayer plain cloth when requiring to be semi shading.

In an embodiment, the vehicle curtain may further include an inner covering plain cloth, and the inner covering plain cloth is disposed on an inner side of the interlayer plain cloth facing away from the outer mesh cloth to cover the interlayer plain cloth for aesthetic purposes. An outer side of an upper end of the inner covering plain cloth is sewn and connected to outer sides of the upper interlayer plain cloth and the outer mesh cloth.

In an embodiment, the lower interlayer plain cloth includes a left plain cloth and a right plain cloth independent from each other to realize an opening mode in which the interlayer plain cloth can be pulled left and right. In order to make opening and closing of the left plain cloth and the right plain cloth more stable and smoothly, a left side of the left plain cloth and a right side of the right plain cloth may be sewn and positioned to the outer mesh cloth individually, and a right side of the left plain cloth and a left side of the right plain cloth may be attachable together through a button, a strap, a magic tape, or a zipper.

In an embodiment, the mounting connection blocks may be magnetic absorbing blocks, may also be magic tapes or adhesive tapes, to realize the rapid installation of the curtain on a door frame of the vehicle.

In an embodiment, in order to ensure the privacy inside the vehicle and the impression of people inside the vehicle, the outer mesh cloth may be made of transparent gauze (also referred to as georgette), and a color of the outer mesh cloth is preferably black or gray. The interlayer plain cloth or the inner covering plain cloth may be selected as a sunshade cloth, which can effectively block ultraviolet. As another embodiment of the disclosure, a layer of sunshade coating may be disposed on a surface of the interlayer plain cloth or the inner covering plain cloth to achieve the purpose of sunscreen.

In an embodiment, in order to prevent clothes from shedding and fraying, the outer mesh cloth, the interlayer plain cloth, and the inner cover plain cloth are processed with lockstitch edges to ensure the service life of the product.

In an embodiment, a zipper base is disposed between the upper interlayer plain cloth and the lower interlayer plain cloth, and two sliders are mounted on the zipper base. The two sliders are respectively disposed on a right side of the left plain cloth and a left side of the right plain cloth. The user can open and close the left plain cloth and the right plain cloth of the lower interlayer plain cloth through the zipper to realize the semi shading function (that is, shading light only through the outer mesh cloth) and the full shading function of the vehicle window.

Compared with the related art, beneficial effects of the disclosure are as follows. The design is simple in structure and easy to use. The double-layer structure of mesh cloth and plain cloth is used, and in this situation the user can opening and close the interlayer plain cloth and the inner covering plain cloth through opening and closing such as the guide rail or the zipper to realize the semi shading function and full shading function of the vehicle window, and greatly improve the user's experience.

### BRIEF DESCRIPTION OF DRAWINGS

FIG. 1 is a schematic structural diagram of a vehicle curtain according to a first embodiment of the disclosure.

FIG. 2 is another schematic structural diagram of the vehicle curtain according to the first embodiment of the disclosure.

FIG. 3 is a schematic structural diagram of a vehicle curtain according to a second embodiment of the disclosure.

FIG. 4 is a schematic structural diagram of a vehicle curtain according to a third embodiment of the disclosure.

FIG. 5 is a schematic structural diagram showing a connection of an interlayer plain cloth, an outer mesh cloth, and an inner covering plain cloth according to the disclosure.

### DETAILED DESCRIPTION OF EMBODIMENTS

The disclosure will be further described in combination with embodiments given in the drawings. The specific embodiments are only illustrative specific embodiments of the disclosure, and specific methods, devices, conditions, materials, etc. cited herein are not intended to limit the disclosure or the corresponding specific embodiments. In addition, it should be noted that the devices in the drawings are only used to express their relative positions and are not drawn to scale.

In the description of this specification, reference to the terms “preferably”, “an embodiment”, “another embodiment”, or “some embodiments” means that specific features, structures, materials or features described in combination with this embodiment are included in at least one embodiment of the disclosure. In this specification, illustrative expressions of the above terms do not necessarily refer to the same embodiment. Moreover, the specific features, structures, materials or features described may be combined in any one or more embodiments in a suitable manner.

First embodiment

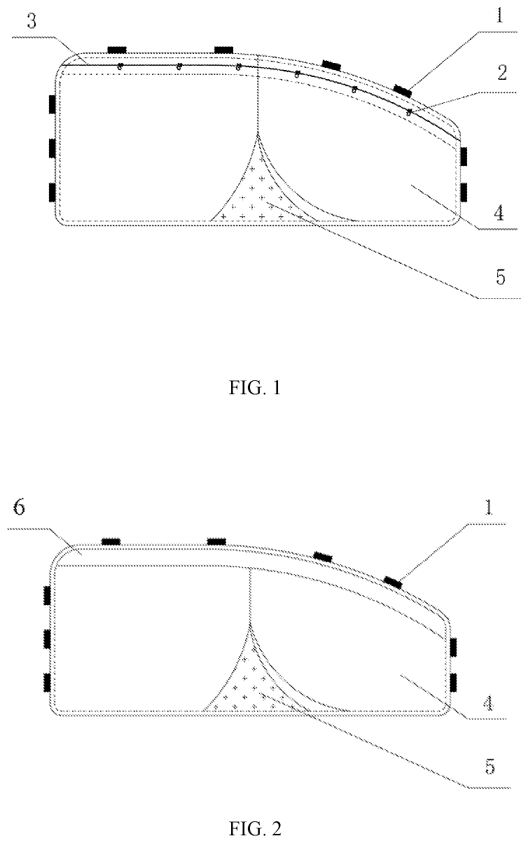

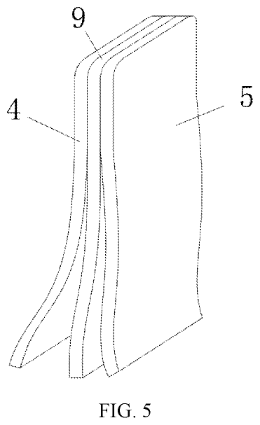

As shown in FIG. 1, FIG. 2, and FIG. 5, a vehicle curtain capable of being used in double-layer includes an outer mesh cloth 5 and an interlayer plain cloth 4 each having a shape consistent with a shape of a vehicle window. The outer mesh cloth 5 is arranged an outer side of the interlayer plain cloth 4. An edge of the outer mesh cloth 5 is disposed with multiple mounting connection blocks 1. The interlayer plain cloth 4 includes an upper interlayer plain cloth and a lower interlayer plain cloth, an outer edge of the upper interlayer plain cloth is sewn and connected to an outer edge of an upper portion of the outer mesh cloth 5, and the lower interlayer plain cloth is movably connected to the upper interlayer plain cloth. In this embodiment, a guide rail 3 is disposed on the upper interlayer plain cloth, multiple hooks 2 are slidably mounted on the guide rail 3, and the lower interlayer plain cloth is connected to the multiple hooks 2. Through the sliding of the multiple hooks 2, the lower interlayer plain cloth can be pulled more smoothly. In practical application, the hooks 2 may be omitted, an upper portion of the lower interlayer plain cloth is sleeved on the guide rail 3, and opening and closing of the interlayer plain cloth 4 can be completed by pulling and folding the lower interlayer plain cloth. The scheme is not limited to those skilled in the art using any movable connection mode that can open and close the interlayer plain cloth 4 in the related art.

In an embodiment, the curtain may further include an inner covering plain cloth 9 (as shown in FIG. 5), and the inner covering plain cloth 9 is arranged an inner side of the interlayer plain cloth facing away from the outer mech cloth to cover the interlayer plain cloth for aesthetic purposes. An outer side of an upper end of the inner covering plain cloth 9 is sewn and connected to outer sides of the upper interlayer plain cloth and the outer mesh cloth 5.

In an embodiment, the upper interlayer plain cloth is disposed with a curtain head 6 for hiding the guide rail 3 and the multiple hooks 2. The curtain head 6 may be formed by sewing the covering plain cloth, or can be formed by sewing a folding portion of the upper interlayer plain cloth or a folding portion of an upper portion of the outer mesh cloth 5. On the one hand, it can make the product more beautiful, and on the other hand, it can protect the guide rail 3 and the hook 2 from being damaged.

In an embodiment, the lower interlayer plain cloth may include a left plain cloth and a right plain cloth independent from each other to realize an opening mode in which the lower interlayer plain cloth can be pulled left and right. In order to make the opening and closing of the left plain cloth and the right plain cloth more stable and smoothly, a left side of the left plain cloth and a right side of the right plain cloth may be sewn and positioned to the outer mesh cloth individually, so that the left plain cloth and the right plain cloth will not be displaced to thereby prevent leakage of light from edges. A right side of the left plain cloth and a left side of the right plain cloth may be attachable together through a button, a strap, a magic tape (also referred to as VELCRO), or a zipper, etc., which facilitate mutual adhesion of the left plain cloth and the right plain cloth, so that the lower interlayer plain cloth is closed more tightly.

In an embodiment, the mounting connection blocks 1 may be magnetic absorbing blocks, and may also be magic tapes, adhesive tapes, etc. to quickly install the curtain on a door frame of the vehicle.

In an embodiment, in order to ensure the privacy inside the vehicle and the impression of people inside the vehicle, the outer mesh cloth 5 may be made of transparent gauze (also referred to as georgette), and a color of the outer mesh cloth is preferably black or gray. The interlayer plain cloth or the inner covering plain cloth 9 may be selected as a sunshade cloth, which can effectively block ultraviolet. As another embodiment of the disclosure, a layer of sunshade coating may be disposed on a surface of the interlayer plain cloth or the inner covering plain cloth 9 to achieve the purpose of sunscreen.

In an embodiment, in order to prevent clothes from shedding and fraying, the outer mesh cloth, the interlayer plain cloth, and the inner covering plain cloth 9 are processed with lockstitch edges to ensure the service life of the product.

The principle of use of this scheme is as follows. The window curtain is adsorbed on the door frame through the mounting connection blocks 1, and when the vehicle curtain is used, it can slide left and right by pulling the interlayer plain cloth 4 in left and right directions. In this way, a user can close the interlayer plain cloth 4 to completely block external lights, and can open the interlayer plain cloth 4 to see outside visual field through the outer mesh cloth 5, thereby achieving two functions of full shading and semi shading, which greatly improves the user's experience.

Second embodiment

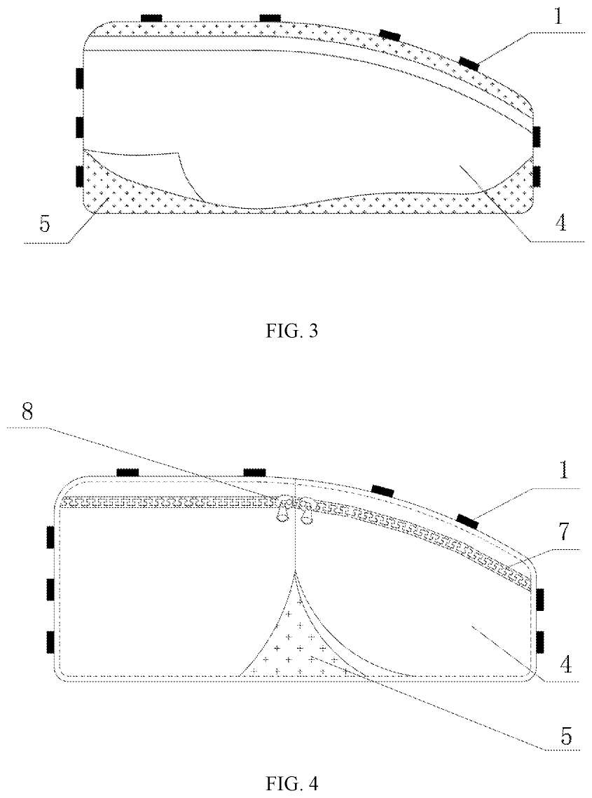

As shown in FIG. 3, a vehicle curtain capable of being used in double-layer includes an outer mesh cloth 5 and an interlayer plain cloth 4 each having a shape consistent with a vehicle window. The outer mesh cloth 5 is arranged an outer side of the interlayer plain cloth 4. An edge of the outer mesh cloth 5 is disposed with multiple mounting connection blocks 1. The interlayer plain cloth 4 includes an upper interlayer plain cloth and a lower interlayer plain cloth, an outer edge of the upper interlayer plain cloth is sewn and connected to an outer edge of an upper portion of the outer mesh cloth 5, and the lower interlayer plain cloth is movably connected to the upper interlayer plain cloth. The lower interlayer plain cloth is detachably connected to the upper interlayer plain cloth through a zipper, and thus a user can directly remove the lower interlayer plain cloth when requiring to be semi shading. In practical application, detachable connection of the lower interlayer plain cloth and the upper interlayer plain cloth may be realized by using buttons, straps, or magic tapes. Other structural features of the scheme can be referred to that of the first embodiment and will not be described here.

Third embodiment

Specifically, as shown in FIG. 4, a vehicle curtain capable of being used in double-layer includes an outer mesh cloth 5 and an interlayer plain cloth 4 each having a shape consistent with a shape of a vehicle window. The outer mesh cloth 5 is arranged an outer side of the interlayer plain cloth 4. An edge of the outer mesh cloth 5 is disposed with multiple mounting connection blocks 1. The interlayer plain cloth 4 includes an upper interlayer plain cloth and a lower interlayer plain cloth, an outer edge of the upper interlayer plain cloth is sewn and connected to an outer edge of an upper portion of the outer mesh cloth 5, and the lower interlayer plain cloth is movably connected to the upper interlayer plain cloth. In this embodiment, the upper interlayer plain cloth is disposed with a zipper base 7, and the zipper base 7 is disposed with two sliders 8. The two sliders 8 are respectively arranged on a right side of the left plain cloth and a left side of the right plain cloth. In this situation, a user can open and close the left plain cloth and the right plain cloth of the lower interlayer plain cloth through the zipper to realize the semi shading function of (that is, shading light only through the outer mesh cloth) and the full shading function of the vehicle window. In practical applications, detachable connection of the lower interlayer plain cloth and the upper interlayer plain cloth may be realized by using buttons, straps, or magic tapes. Other structural features of the scheme can be referred to that of the first embodiment and will not be described here.

The above is only preferred embodiments of the disclosure, and cannot be used to limit the scope of the implementation of the disclosure, that is, all simple equivalent changes and modifications made according to the scope of the disclosure and the description of the disclosure are still within the scope of the patent of the disclosure.

What is claimed is:

1. A vehicle curtain, comprising an outer mesh cloth and an interlayer plain cloth;
wherein an edge of the outer mesh cloth is disposed with a plurality of mounting connection blocks; and
wherein the interlayer plain cloth comprises an upper interlayer plain cloth and a lower interlayer plain cloth, the upper interlayer plain cloth is sewn and connected to the outer mesh cloth, and the lower interlayer plain cloth is movably connected to the upper interlayer plain cloth.

2. The vehicle curtain according to claim 1, wherein the upper interlayer plain cloth is disposed with a guide rail, the guide rail is slidably disposed with a plurality of hooks, and the lower interlayer plain cloth is connected to the plurality of hooks.

3. The vehicle curtain according to claim 2, wherein the upper interlayer plain cloth is disposed with a curtain head configured to hide the guide rail and the plurality of hooks.

4. The vehicle curtain according to claim 1, wherein the lower interlayer plain cloth is detachably connected to the upper interlayer plain cloth through one selected from the group consisting of buttons, straps, magic tapes, and zippers.

5. The vehicle curtain according to claim 1, further comprising an inner covering plain cloth, wherein the inner covering plain cloth is disposed on an inner side of the interlayer plain cloth facing away from the outer mesh cloth, and an upper end of the inner covering plain cloth is sewn and connected to the upper interlayer plain cloth and the outer mesh cloth.

6. The vehicle curtain according to claim 1, wherein the lower interlayer plain cloth comprises a left plain cloth and a right plain cloth independent from each other.

7. The vehicle curtain according to claim 6, wherein a left side of the left plain cloth and a right side of the right plain cloth are individually sewn and positioned to the outer mesh cloth.

8. The vehicle curtain according to claim 6, wherein a right side of the left plain cloth and a left side of the right plain cloth are attachable together through a button, a strap, a magic tape, or a zipper.

9. The vehicle curtain according to claim 1, wherein the mounting connection blocks comprise magnetic absorbing blocks.

10. The vehicle curtain according to claim 5, wherein the outer mesh cloth, the interlayer plain cloth, and the inner covering plain cloth are processed with lockstitch edges.

11. The vehicle curtain according to claim 6, wherein a zipper base is disposed between the upper interlayer plain cloth and the lower interlayer plain cloth, the zipper base is mounted with two sliders, and the two sliders are respectively disposed on a right side of the left plain cloth and a left side of the right plain cloth.
